(19) United States
(12) Patent Application Publication
(10) Pub. No.: US 2019/0095870 A1
(43) Pub. Date: Mar. 28, 2019

(54) CURATED DAILY CONTENT PRESENTATION FOR MOBILE DEVICES

(71) Applicants: Steve Byrne, Vancouver, WA (US); David Folk, San Francisco, CA (US); Rich Green, Los Altos Hills, CA (US); Eonju Lee, San Jose, CA (US); Joseph Mao, Sunnyvale, CA (US); Brian Ng, Santa Clara, CA (US); Andreas Sandberg, Pacifica, CA (US); Zac Sprackett, Kanata, CA (US)

(72) Inventors: Steve Byrne, Vancouver, WA (US); David Folk, San Francisco, CA (US); Rich Green, Los Altos Hills, CA (US); Eonju Lee, San Jose, CA (US); Joseph Mao, Sunnyvale, CA (US); Brian Ng, Santa Clara, CA (US); Andreas Sandberg, Pacifica, CA (US); Zac Sprackett, Kanata, CA (US)

(21) Appl. No.: 15/716,427

(22) Filed: Sep. 26, 2017

(51) Int. Cl. G06Q 10/10; G06F 17/30

(52) U.S. Cl. CPC G06Q 10/1095; G06F 17/30864

(57) ABSTRACT

A method for the curated presentation of daily content in a mobile device includes detecting a morning hour in memory of a mobile device of an end user, and in response to the detection of the morning hour, the mobile device: queries a C&S data store for all tasks and meetings scheduled for a current day, identifies a multiplicity of contacts associated with the tasks and meetings, retrieves from over the Internet from at least one Web site, information pertaining to one of the contacts, determines from the information, a contemporaneous value corresponding to a record field for the one of the contacts that differs from an existing value for the record field, prompts the end user to update the record field and, on condition the end user approves in response to the prompting, updates the record field with the contemporaneous value but otherwise maintains the existing value.

### BACKGROUND OF THE INVENTION

### Field of the Invention

The present invention relates to the field of calendaring and scheduling (C&S) and more particularly to a daily agenda view in a mobile device.

### Description of the Related Art

C&S systems have formed the core component of personal information management software and firmware applications for decades. Initially, a mere calendar display, modern calendaring systems provide scheduling and alarm functions in addition to full integration with contact management, time entry, billing and project management applications. The typical calendaring application minimally provides a mechanism for scheduling an event to occur on a certain date at a certain time. Generally, the event can be associated with a textual description of the event. More advanced implementations also permit the association of the scheduled event with a particular contact, a particular project, or both. Furthermore, most calendar applications provide functionality for setting an alarm prior to the occurrence of the event, as well as archival features.

C&S systems generally provide an agenda view in which, for a particular day, an agenda is assembled and presented to the end user. The agenda typically includes a collection of one or more meetings scheduled on the particular day, and one or more tasks designated to be completed on the particular day. Advanced forms of the agenda may also include extraneous data such as an indication of the weather, traffic conditions and one or more news headlines. Other advanced forms of the agenda view present a listing of contacts relevant to meetings and tasks also associated with the particular day. Of note, some agenda views permit the end user to both select the category of content presented in the agenda view, and also a visual arrangement of the content in the agenda view.

The modern CRM application expands upon the basis notion of C&S by collecting, tracking and storing customer relationship data so as to facilitate the sales and marketing efforts of the end user. C&S functions such as meeting, task and contact management form part and parcel of the collection, tracking and storage of customer relationship data. As well, like the traditional C&S, the modern CRM application provides an agenda view in the form of a dashboard in which not only are the day's meetings and associated tasks presented, but also various and sundry news items pertinent to the customers of the CRM application as sourced from Internet sources including social media.

Given the vastness of the Internet, it will be apparent that enormous amounts of data pertinent to the contacts of a CRM application may be sourced at any given time. As such, presenting the entirety of the sourced information can prove more burdensome than helpful as some end users find an excessive amount of third party information in the dashboard distracting and unhelpful—especially when presented in the display of a mobile device such as a smart phone or tablet computer. Yet, others may find too little third party information unhelpful. Thus, the static nature of presenting third party information in the dashboard view of a CRM application has proven less than optimal.

### BRIEF SUMMARY OF THE INVENTION

Aspects of the present disclosure provide for the curated presentation of daily content in a mobile device. In accordance with one aspect of an embodiment of Applicants' invention, a method for the curated presentation of daily content in a mobile device includes an initial detection of a morning hour in memory of a mobile device of an end user. In response to the detection of the morning hour, a C&S data store is queried for all tasks and meetings scheduled for a current day, and a multiplicity of contacts associated with the tasks and meetings are identified. Then, information pertaining to one of the contacts is retrieved from over the Internet from at least one Web site, and a contemporaneous value corresponding to a record field for the one of the contacts is determined from the information that differs from an existing value for the record field. As such, the end user is prompted in the mobile device to update the record field with the contemporaneous value replacing the existing value. On condition the end user approves the update in response to the prompting, the record field is updated with the contemporaneous value. But, otherwise the existing value is maintained.

In one aspect of the embodiment, a new value is determined from the information that corresponds to a record field that has no existing value for the one of the contacts. As such, the end user is prompted in the mobile device to add the new value to the record field, and, on the condition that the end user approves in response to the prompting, the new value is added to the record field. But, otherwise the new value is ignored. In another aspect of the embodiment, the information pertaining to one of the contacts is filtered to a limited amount of values for corresponding record fields based upon a pre-stored threshold breadth setting in the mobile device, in so far as a higher setting permits more values and a lower setting permits fewer values. In yet another aspect of the embodiment, the prompting of the end user in the mobile device to either update the record field with the contemporaneous value replacing the existing value, or to add the new value to the record field, may be bypassed on the condition that previously the end user had elected to not approve of the updating of the record field or the adding of the new value to the record field, as the case may be, in response to a previous prompting.

In another embodiment of the invention, a data processing system may be configured for the curated presentation of daily content in a mobile device. The system includes a mobile device having memory, a display and at least one processor. The system also includes a C&S data store storing in the mobile device tasks and meetings scheduled on different days at different times in association with different contacts. Finally, the system includes a curated presentation module that includes computer program instructions executing in the memory of the mobile device. The program instructions detect a morning hour in the memory of the mobile device of an end user, and in response to the detection of the morning hour, query the C&S data store for all tasks and meetings scheduled for a current day, identify a multiplicity of contacts associated with the tasks and meetings, retrieve from over the Internet from at least one Web site, information pertaining to one of the contacts, determine from the information, a contemporaneous value corresponding to a record field for the one of the contacts that differs from an existing value for the record field, prompt the end user in the mobile device to update the record field with the contemporaneous value replacing the existing value, and, on the condition that the end user approves in response to the prompting, update the record field with the contemporaneous value but otherwise maintain the existing value.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of the curated presentation of daily content in a mobile device;

FIG. 2 is a schematic illustration of a data processing system adapted for the curated presentation of daily content in a mobile device; and,

FIG. 3 is a flow chart illustrating a process for the curated presentation of daily content in a mobile device.

### DETAILED DESCRIPTION OF THE INVENTION

Embodiments of the invention provide for the curated presentation of daily content in a CRM application. In accordance with an embodiment of the invention, a current date is determined at a morning hour specified within memory of a computing device. A set of events scheduled for the current date is then determined by way of query to a data store whether disposed on the mobile device or remotely in a server. Thereafter, one or more contacts in the data store are identified as being associated with one or more events scheduled for the current date. Queries are then issued over the Internet to retrieve different records pertaining to different values for different record fields of each of the identified contacts. However, the retrieved values for the different record fields are filtered in accordance with a breadth parameter established by the end user in so far as a smaller value for the parameter permits only a smaller range of values to survive the filtering while a larger value for the parameter permits a larger range of values to survive the filtering.

Thereafter, the filtered values are presented in an agenda view of the mobile device and compared to existing values for the contacts. Discrepancies are highlighted in the agenda view and the end user is prompted to update or ignore proposed changes to values in the record fields of the contacts. As well, the end user is prompted to add new values for new record fields for the contacts. Optionally, proposed changes to values in the record fields of the contacts, or new values for new record fields for the contacts may be automatically suppressed responsive to the recognition that the end user had previously indicated a preference not to update the proposed changes or add the new values for the new record values. In this way, the content of the agenda view may be curated according to the individual tastes of different end users of the CRM application.

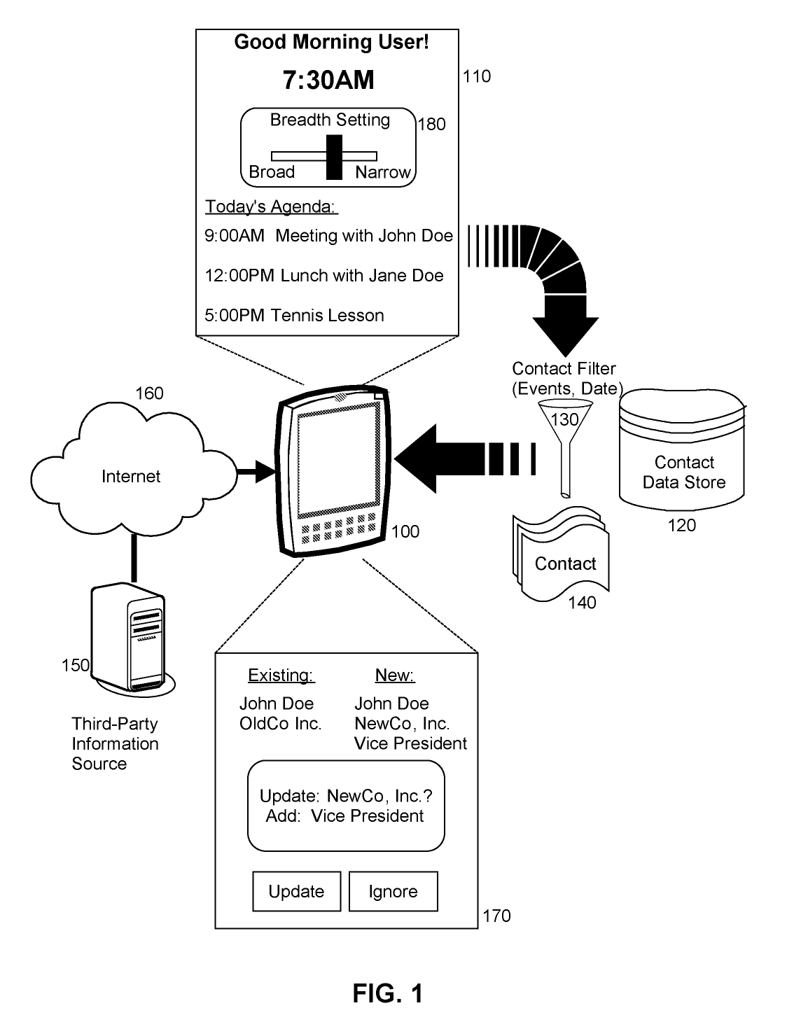

In further illustration, FIG. 1 is pictorial illustration of the curated presentation of daily content in a mobile device. As shown in FIG. 1, an agenda view 110 is presented in a mobile device 100. A current time and date may be presented in the agenda view 110 and the agenda view 110 may provide a listing of events including tasks and meetings scheduled to occur on the current day. As well, the agenda view 110 provides a breadth setting control 180. The breadth setting control 180 indicates a breadth of searching that may occur in connection to a query issued with respect to one or more contacts viewable through the mobile device 100.

Of note, when a morning hour is detected, the events schedule for the current day are retrieved from a C&S data store accessible to the mobile device 100 and one or more contacts in a contact data store 120 are subjected to a filtering operation 130 to generate a contacts subset 140 of contacts associated with the retrieved events. Thereafter, one or more queries are issued over the Internet 160 to one or more Web sites 150 (only a single site shown for ease of illustration) in connection with the contacts in the subset 140. Importantly, the extent of the number and nature of the keywords of the one or more queries depends upon the breadth setting established by the breadth setting control 180. For instance, a table may be established correlating certain sets of keywords for use in formulating the queries with a particular breadth setting with a larger breadth setting producing one or more queries with multiple keywords whereas a particular breadth setting with a smaller breadth setting produces one or more queries with fewer keywords.

In response to the one or more queries, data pertaining to the contacts in the subset 140 are extracted from the query results, the data is classified by data type, and values determined for the different classifications. Then, existing values for different record fields of records corresponding to the contacts in the subset 140 are retrieved from the contact data store 120 and those existing values are compared to the values for the different classifications with the different classification corresponding to different record fields of the records. To the extent that an existing value for one of the record fields of one of the contacts in the subset 140 differs from a value determined from the query results for the one of the record fields of the one of the contacts, a prompt 170 is presented in the mobile device 100. The prompt presents the existing values for the record fields for the one of the contacts, and also those values extracted from the query results. Different values are highlighted as are values extracted from the query for a record field of he one of the contacts lacking a value.

The prompt permits a selection of updating/adding the values extracted from the query, or ignoring the difference. On the condition that an end user elects to update/add the values extracted from the query, the values extracted from the query replace the existing values for the one of the contacts, or the values extracted from the query are added as new values for record fields of the one of the contacts, as the case may be. In this way, the data introduced into the contact data store are curated.

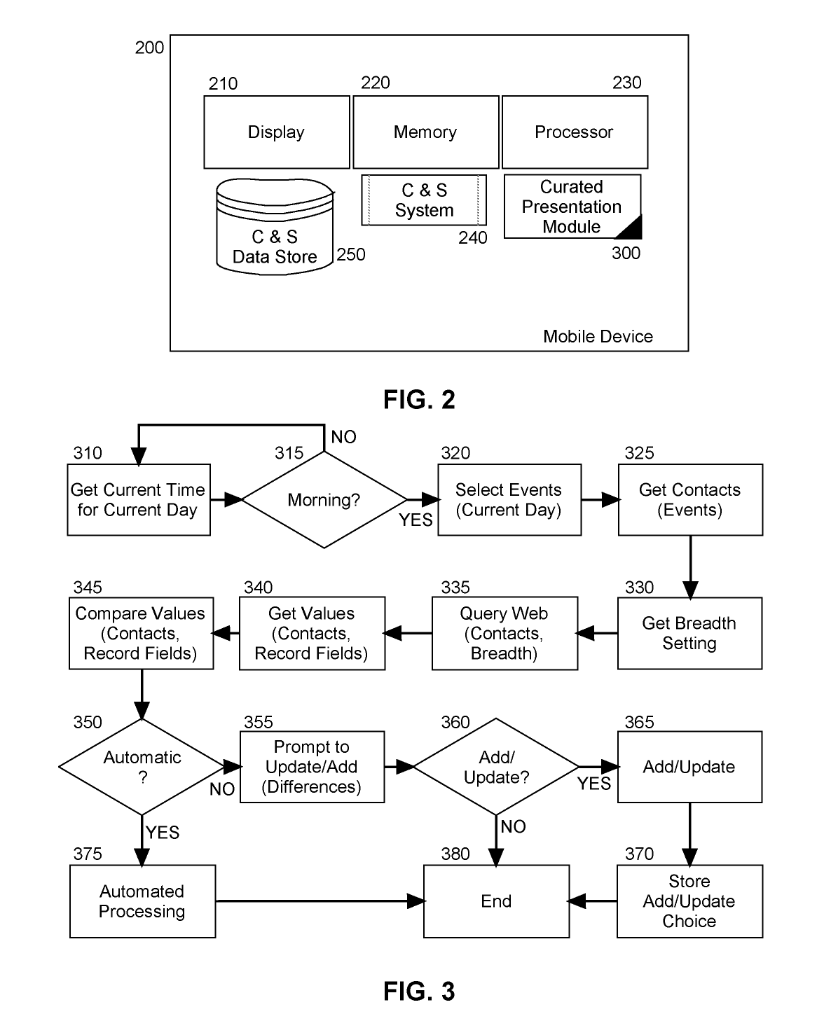

FIG. 2 is a schematic illustration of a data processing system adapted for the curated presentation of daily content in a mobile device. The system includes a mobile device 200 such as a smart phone or tablet computer. The mobile device 200 includes memory 220, one or more processors 230 and a display 210. A C&S system 240 programmatically executes in the memory 220 of the mobile device 200 by the one or more processors 230 utilizing calendaring and contact data in a C&S data store 250, such as a table, flat file or database, in order to provide C&S functions in the mobile device 200.

Of note, a curated presentation module 300 executes in the the memory 220 of the mobile device 200. The presentation module 300 includes program code enabled upon execution to determine a current day and time of day. In response to the determination that a morning hour has passed, events scheduled to occur on the current day are retrieved and contacts associated with the retrieved events are identified. A breadth setting is then loaded into the memory 220 and used as a basis for formulating one or more Web site queries over the Internet for each of the retrieved contacts in order to retrieve data relating to the retrieved contacts. Thereafter, the query results are parsed and classified to identify different values for different record fields of each of the retrieved contacts. Once the different values are identified, the different values are compared to existing values, if any, for corresponding record fields of the contacts. Discrepancies are noted and presented in a prompt in the display 210 providing the end user the option to update the values for the corresponding record files (or add new values for record fields where no values previously had been present), or to ignore the discrepancies.

In even yet further illustration of the operation of the curated presentation module 300, FIG. 3 is a flow chart illustrating a process for the curated presentation of daily content in a mobile device. Beginning in block 310, a current time and current day for the mobile device is determined. In decision block 315, it is determined if the current time is a specified morning hour. If so, in block 320, events in the C&S system scheduled for the current day are retrieved and presented in the display of the mobile device. As well, in block 325, one or more contacts associated in the C&S system with the retrieved events are retrieved.

In block 330, a breadth setting is loaded into memory and, based upon the breadth setting and in block 335 one or more Web site queries are formed with one or more keywords for each of the contacts and the queries are transmitted over the Internet to one or more search engines, one or more Web sites, or both. In block 340, values are received in one or more results provided in response to the queries. The values are extracted from the results, classified according to type and correlated to different record fields of the contacts. In block 345, the values extracted from the results are compared to existing values for corresponding ones for the record fields or respective ones of the contacts.

In decision block 350, it is determined if automatic updating has been selected. If so, in block 375, the existing values for the record fields for respective ones of the contacts are replaced with differing ones of the values extracted from the results. In this regard, past selections by the end user to ignore or accept recommendations to update and/or add extracted values can be tracked and, once a threshold number of selections are recorded to ignore an update to a particular record field, it is presumed that the end user does not prefer to apply updates or new additions to that record field. Conversely, once a threshold number of selections are recorded to apply an update to a particular record field, or to add a new value to a previously unpopulated record field, it is presumed that the end user prefers to add updated values of the particular record field or to add new values to unpopulated record fields. Consequently, automated processing of the extracted values without first prompting the end user may occur in block 376 when updating a particular field, adding a new value to a particular field or ignoring an update or addition to a particular field, once a threshold number of selections are recorded indicating a user preference.

To the extent that automatic updating is not selected in decision block 350, in block 355 a prompt is generated in the display of the mobile device for the end user to accept or ignore the updating and/or adding of extracted values to corresponding record fields for the contacts. In decision block 360, if the end user elects to accept the recommendations of the prompt, in block 365 the extracted values are updated and/or added as the case may be to the corresponding record fields and in block 370, the selection by the end user is recorded for the purpose of computed automated processing. Finally, in block 380 the process ends.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for the curated presentation of daily content in a mobile device, the method comprising:
detecting a morning hour in memory of a mobile device of an end user; and,
responsive to the detection of the morning hour:
querying a calendaring and scheduling (C&S) data store for all tasks and meetings scheduled for a current day,
identifying a multiplicity of contacts associated with the tasks and meetings,
retrieving from over the Internet from at least one Web site, information pertaining to one of the contacts,
determining from the information, a contemporaneous value corresponding to a record field for the one of the contacts that differs from an existing value for the record field,
prompting the end user in the mobile device to update the record field with the contemporaneous value replacing the existing value, and,
on condition the end user approves in response to the prompting, updating the record field with the contemporaneous value but otherwise maintaining the existing value.

2. The method of claim 1, further comprising:
determining from the information, a new value corresponding to a record field that has no existing value for the one of the contacts,
prompting the end user in the mobile device to add the new value to the record field, and,
on condition the end user approves in response to the prompting, adding the new value to the record field but otherwise ignoring the new value.

3. The method of claim 1, further comprising filtering the information pertaining to one of the contacts, to a limited amount of values for corresponding record fields based upon a pre-stored threshold breadth setting in the mobile device, a higher setting permitting more values and a lower setting permitting fewer values.

4. The method of claim 1, further comprising bypassing the prompting of the end user in the mobile device to update the record field with the contemporaneous value replacing the existing value on condition that previously the end user had elected to not approve of the updating of the record field with the contemporaneous value in response to a previous prompting.

5. The method of claim 1, further comprising bypassing the prompting of the end user in the mobile device to add the new value to the record field on condition that previously the end user had elected to not approve of the adding of the new value to the record field in response to a previous prompting.

6. A data processing system configured for the curated presentation of daily content in a mobile device, the system comprising:
a mobile device comprising memory, a display and at least one processor;
a calendaring and scheduling (C&S) data store storing in the mobile device tasks and meetings scheduled on different days at different times in association with different contacts; and,
a curated presentation module comprising computer program instructions executing in the memory of the mobile device, the program instructions performing:
detecting a morning hour in the memory of the mobile device of an end user; and,
responsive to the detection of the morning hour:
querying the C&S data store for all tasks and meetings scheduled for a current day,
identifying a multiplicity of contacts associated with the tasks and meetings,
retrieving from over the Internet from at least one Web site, information pertaining to one of the contacts,
determining from the information, a contemporaneous value corresponding to a record field for the one of the contacts that differs from an existing value for the record field,
prompting the end user in the mobile device to update the record field with the contemporaneous value replacing the existing value, and,
on condition the end user approves in response to the prompting, updating the record field with the contemporaneous value but otherwise maintaining the existing value.

7. The system of claim 6, wherein the program instructions further perform:
determining from the information, a new value corresponding to a record field that has no existing value for the one of the contacts,
prompting the end user in the mobile device to add the new value to the record field, and,
on condition the end user approves in response to the prompting, adding the new value to the record field but otherwise ignoring the new value.

8. The system of claim 6, wherein the program instructions further perform filtering the information pertaining to one of the contacts, to a limited amount of values for corresponding record fields based upon a pre-stored threshold breadth setting in the mobile device, a higher setting permitting more values and a lower setting permitting fewer values.

9. The system of claim 6, wherein the program instructions further perform bypassing the prompting of the end user in the mobile device to update the record field with the contemporaneous value replacing the existing value on condition that previously the end user had elected to not approve of the updating of the record field with the contemporaneous value in response to a previous prompting.

10. The system of claim 6, wherein the program instructions further perform bypassing the prompting of the end user in the mobile device to add the new value to the record field on condition that previously the end user had elected to not approve of the adding of the new value to the record field in response to a previous prompting.

11. A computer program product for the curated presentation of daily content in a mobile device, the computer program product including a non-transitory computer readable storage medium having program instructions embodied therewith, the program instructions executable by a device to cause the device to perform a method including:
detecting a morning hour in memory of a mobile device of an end user; and,
responsive to the detection of the morning hour:
querying a calendaring and scheduling (C&S) data store for all tasks and meetings scheduled for a current day,
identifying a multiplicity of contacts associated with the tasks and meetings,
retrieving from over the Internet from at least one Web site, information pertaining to one of the contacts,
determining from the information, a contemporaneous value corresponding to a record field for the one of the contacts that differs from an existing value for the record field,
prompting the end user in the mobile device to update the record field with the contemporaneous value replacing the existing value, and,
on condition the end user approves in response to the prompting, updating the record field with the contemporaneous value but otherwise maintaining the existing value.

12. The computer program product of claim 11, wherein the method further comprises:
determining from the information, a new value corresponding to a record field that has no existing value for the one of the contacts,
prompting the end user in the mobile device to add the new value to the record field, and,
on condition the end user approves in response to the prompting, adding the new value to the record field but otherwise ignoring the new value.

13. The computer program product of claim 11, wherein the method further comprises filtering the information pertaining to one of the contacts, to a limited amount of values for corresponding record fields based upon a pre-stored threshold breadth setting in the mobile device, a higher setting permitting more values and a lower setting permitting fewer values.

14. The computer program product of claim 11, wherein the method further comprises bypassing the prompting of the end user in the mobile device to update the record field with the contemporaneous value replacing the existing value on condition that previously the end user had elected to not approve of the updating of the record field with the contemporaneous value in response to a previous prompting.

15. The computer program product of claim 11, wherein the method further comprises bypassing the prompting of the end user in the mobile device to add the new value to the record field on condition that previously the end user had elected to not approve of the adding of the new value to the record field in response to a previous prompting.
